(19) United States
(12) Patent Application Publication
(10) Pub. No.: US 2017/0160940 A1
(43) Pub. Date: Jun. 8, 2017

(54) DATA PROCESSING METHOD AND APPARATUS OF SOLID STATE DISK

(71) Applicant: SAMSUNG ELECTRONICS CO., LTD., SUWON-SI (KR)

(72) Inventors: FEI YANG, XI'AN (CN); HAIBO TANG, XI'AN (CN); KUN DOU, XI'AN (CN); NA LI, XI'AN (CN)

(21) Appl. No.: 15/362,558

(22) Filed: Nov. 28, 2016

(30) Foreign Application Priority Data
Dec. 3, 2015 (CN) 201510880930.5

(51) Int. Cl. G06F 3/06

(52) U.S. Cl. CPC G06F 3/064; G06F 3/0604; G06F 3/0679; G06F 3/0652

(57) ABSTRACT

A method for processing data in a solid state disk (SSD) includes receiving a write command for a first data, and finding a blank block in response to the write command, wherein each page included in the blank block is a blank page; receiving the first data; and writing the first data beginning from the blank block. Because data is only written into a blank block in a write process, only one data is stored in each block, and after data is deleted, no valid page is included in the block that stored the deleted data, and there is no need to move a valid data in a garbage collection process that erases the block, which can improve an efficiency of garbage collection and usage of the SSD.

### CROSS-REFERENCE TO RELATED APPLICATION

This application claims priority under 35 U.S.C. 119 from Chinese Patent Application No. 201510880930.5 filed on Dec. 3, 2015 in the State Intellectual Property Office of the People's Republic of China, and all the benefits accruing therefrom, the contents of which are herein incorporated by reference in their entirety.

### BACKGROUND

1. Technical Field

Embodiments of the present disclosure are generally directed to a storage medium, and more particularly, to a data processing method and apparatus of a solid state disk (SSD).

2. Discussion of the Related Art

An SSD, called a solid disk for short, is a hard disk made from a solid state electronic memory chip array. An SSD uses a memory chip to store data. An SSD includes a number of blocks in which each block includes a number of pages, each page includes a number of bits, a block is a basic unit for erasing, and a page is a basic unit for reading and writing data. With regard to a traditional hard disk driver (HHD), when data needs to be updated, an original address may be directly written into. With regard to an SSD, because each page in an SSD needs to be erased first and then written into due to characteristics of the SSD storage medium, when the SSD updates data, the updated data is written into a blank page, and then the original page for storing the data is set as an invalid page; in this way, an updating operation is finished. When an SSD deletes data, a page that stores the data to be deleted is set as an invalid page. The invalid page cannot be written into again before being erased; such a page is also called a garbage page. When writing data, the number of garbage pages increases, and the available blank pages decreases. At this time, the SSD can select some blocks, move data stored in an available page in these blocks to another blank page, and then erase these blocks. This process is called garbage collection (GC). A new blank page generated after garbage collection may be available for data writing.

During GC, an SSD needs to screen blocks to determine which block contains the fewest valid pages, to minimize the number of pages to be moved during GC, and thus the SSD needs to traverse the blocks to select an appropriate block, and then to move the valid data. Both the traversing operation and the moving operation may consume time. With the continuous writing of data, the data stored in an SSD may become increasingly fragmented, and execution of GC may also become more and more frequent, which can degrade the performance of an SSD.

The processes of writing data, deleting data, and GC as performed by an SSD in the related art will be described below referring to FIGS. 1-3.

FIG. 1 illustrates an example of an existing data distribution after a third data and a fourth data are written into an SSD respectively. As shown in FIG. 1, a first part and second part of the third data are stored in a first block and a second block respectively, and a first part and second part of the fourth data are also stored in the first block and the second block, respectively.

FIG. 2 illustrates an example of an existing data distribution in the SSD after the third data in FIG. 1 is deleted. As shown in FIG. 2, pages for storing the third data in the first block and the second block are set as invalid pages.

FIG. 3 illustrates a flowchart for erasing the first block in FIG. 2. As shown in FIG. 3, because the first block also includes a valid page for storing the fourth data, the fourth data stored in the valid page needs to be moved to a bank block first, the valid page for storing the fourth data in the first block is set as an invalid page, after which the first block can be erased.

### SUMMARY

Embodiments of the present disclosure can provide a data processing method and apparatus for an SSD that can improve the efficiency of GC and usage performance of the SSD by reducing move operations of valid data in a GC process of the SSD.

According to an aspect of the present disclosure, there is provided a method of processing data in an SSD, which includes: receiving a write command for a first data, and finding a blank block in response to the write command, wherein each page included in the blank block is a blank page; receiving the first data; and writing the first data beginning from the blank block.

According to another aspect of the present disclosure, there is provided an apparatus for processing data in an SSD, which includes: a write command receiving unit that receives a write command for a first data, and determines a blank block in response to the writing command, wherein each page included in the blank block is a blank page; a first data receiving unit that receives the first data; and a writing unit that writes the first data beginning from the blank block.

According to another aspect of the present disclosure, there is provided a method of processing data in a solid state disk (SSD) that includes receiving a write command for a first data, and finding a blank block in response to the write command, wherein each page included in the blank block is a blank page, receiving a delete command for a second data, and setting all pages in a block that store the second data to be invalid.

In a method and apparatus for processing data in an SSD according to an exemplary embodiment of the present disclosure, because data is only written into a blank block in a process of writing data, it is ensured that each blank block only stores one data. After the data is deleted, that is after a page that stores the data to be deleted is marked as an invalid page, a block for storing the deleted data includes only an invalid or a blank page or includes only an invalid page, and does not include a valid page. Thus, it is unnecessary to move valid data in a GC process that erases the block, which can improve an efficiency of the GC and usage of the SSD.

### BRIEF DESCRIPTION OF THE DRAWINGS

FIG. 1 illustrates an example of an existing data distribution after a third data and a fourth data are written into an SSD, respectively.

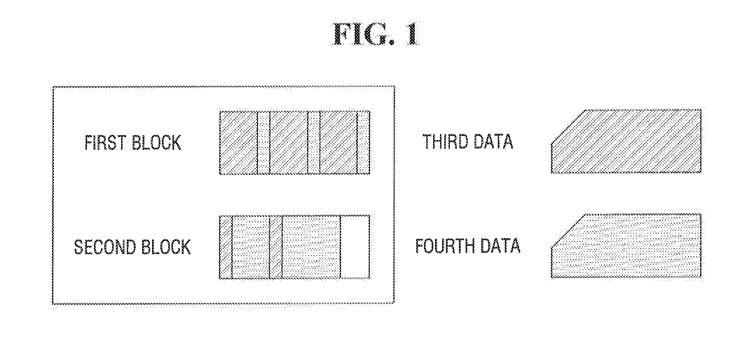

FIG. 2 illustrates an example of an existing data distribution in the SSD after the third data in FIG. 1 is deleted.

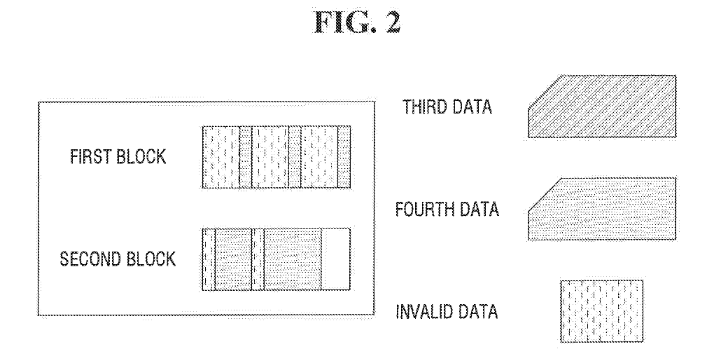

FIG. 3 illustrates a method of erasing a first block in FIG. 2.

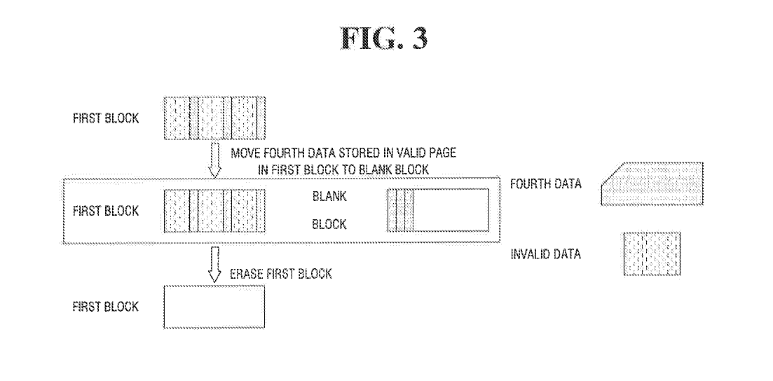

FIG. 4 is a flowchart for writing data in a data processing method of an SSD according to an exemplary embodiment of the present disclosure.

FIG. 5 is a flowchart for deleting data in a data processing method of an SSD according to an exemplary embodiment of the present disclosure.

FIG. 6 is a flowchart for writing data in a data processing method of an SSD according to another exemplary embodiment of the present disclosure.

FIG. 7 is a flowchart for deleting data in a data processing method of an SSD according to another exemplary embodiment of the present disclosure.

FIG. 8 illustrates an example of a data distribution after a third data and a fourth data are written into an SSD, respectively, according to a data write process of an exemplary embodiment of the present disclosure.

FIG. 9 illustrates an example of a data distribution in an SSD after the third data in FIG. 8 is deleted, according to a data delete process of an exemplary embodiment of the present disclosure.

FIG. 10 illustrates a method of erasing a first block in FIG. 9.

FIG. 11 is a block diagram of a data writing module in a data processing apparatus of an SSD according to an exemplary embodiment of the present disclosure.

FIG. 12 is a block diagram of a data deleting module in a data processing apparatus of an SSD according to an exemplary embodiment of the present disclosure.

FIG. 13 is a block diagram of a data writing module in a data processing apparatus of an SSD according to another exemplary embodiment of the present disclosure.

FIG. 14 is a block diagram of a data deleting module in a data processing apparatus of an SSD according to another exemplary embodiment of the present disclosure.

### DETAILED DESCRIPTION OF EXEMPLARY EMBODIMENTS

Exemplary embodiments of the present disclosure will be illustrated below with reference to the accompanying drawings. As is traditional in the field of the inventive concepts, embodiments are described, and illustrated in the drawings, in terms of functional blocks, units and/or modules. Those skilled in the art will appreciate that these blocks, units or modules are physically implemented by electronic (or optical) circuits such as logic circuits, discrete components, microprocessors, hard-wired circuits, memory elements, wiring connections, etc., which may be formed using semiconductor-based fabrication techniques or other manufacturing technologies. In the case of the blocks, units and/or modules being implemented by microprocessors or similar, they may be programmed using software, such as microcode, to perform various functions discussed herein and may optionally be driven by firmware and/or software. Alternatively, each block, unit or module may be implemented by dedicated hardware, or as a combination of dedicated hardware to perform some functions and a processor, such as one or more programmed microprocessors and associated circuitry, to perform other functions. Also, each block, unit or module of the embodiments may be physically separated into two or more interacting and discrete blocks, units or modules without departing from the scope of embodiments of the inventive concepts. Further, the blocks, units or modules of exemplary embodiments may be physically combined into more complex blocks, units or modules without departing from the scope of embodiments of the inventive concept.

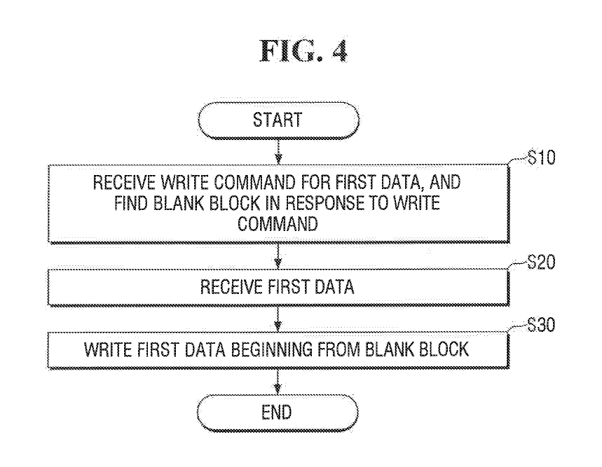

FIG. 4 is a flowchart for writing data in a data processing method according to an exemplary embodiment of the present disclosure.

With reference to FIG. 4, at Step S10, a write command for a first data is received, and a blank block is found in response to the write command. Here, the write command is used to write the first data into the blank block. Each page included in the blank block is a blank page, and the blank block is used only for storing the first data.

When receiving a request to write the first data, a host will transmit the write command for the first data to an SSD, and the SSD will find a blank block after receiving the command. For example, the SSD can search for a blank block. Then the SSD returns the execution result of the command, such as success or failure, to the host. Furthermore, according to an embodiment, the SSD also returns an identification number of the found blank block to the host. The identification number may be defined by the SSD itself, or may correspond to a physical address of the blank block. However, embodiments are not limited thereto, and the identification number may also take other forms.

According to an embodiment, the host will transmit the first data to the SSD after receiving the above execution result. The host may also transmit the identification number of the blank block to the SSD. In this case, the host transmits the identification number of the blank block either before or while transmitting the first data. In other words, the method may further include receiving the identification number of the blank block.

At Step S20, the first data is received.

According to an embodiment, host divides the first data into multiple data segments after receiving the request to write the first data, and transmits the multiple data segments to the SSD after receiving the above execution result. The size of each data segment is less than a size of a page. For example, the size of a page can be an integer multiple of the size of a data segment. Accordingly, at Step S20, the SSD receives the multiple data segments into which the first data is divided.

At Step S30, the first data is written beginning from the blank block. According to an embodiment, the first data is written beginning from a blank block indicated by the received blank block identification number. In other words, the first data is written beginning from the blank block found at Step S10. For example, the first data is written beginning from a beginning address of the blank block.

According to an embodiment, whenever a blank block is filled but the first data is incompletely written, an unwritten content of the first data is written continuously into another blank block. For example, the unwritten content of the first data can be written continuously from the beginning address of another blank block.

According to an embodiment, when the multiple data segments into which the first data is divided are received at Step S20, the multiple data segments are written beginning from a blank block at Step S30. The beginning address of the blank block is physical address for storing the first data segment, and the physical addresses for storing subsequent data segments follow the physical addresses for storing previous data segments.

According to an embodiment, whenever a blank block is filled but the multiple data segments are incompletely written, the unwritten data segments in the multiple data segments are written continuously into other blank blocks. In other words, when an end physical address for storing a previous data segment is an end address of a block, the physical address for storing a subsequent data segment begins from a beginning address of another blank block.

According to an embodiment, the multiple data segments are divided into a plurality of data segment groups. At Step S30, whenever one data segment group is received, the writing is performed once, and whenever a blank block is filled, but there is an incompletely written or unwritten data segment group, the unwritten part of the incompletely written data segment group or the unwritten data segment group is written continuously into another blank block.

In particular, according to an embodiment, the data segment group can be composed of multiple continuous data segments, where the sum of data segment sizes is equal to a page size. A page is a basic unit for writing in an SSD, but the size of each data segment is less than the size of a page. Thus, to efficiently use the storage space, the data segment received at Step S20 is not immediately written at Step S30, but is rather cached until a sum of the sizes of the continuous data segments received at Step S20 is equal to the size of the page. That is, at Step 30, when the sum of the sizes of multiple continuous data segments cached is equal to the size of the page, the multiple cached continuous data segments are written into a physical address of a page corresponding to the logical address of the multiple data segments. That is, at Step 30, whenever one data segment group is received, the writing is performed once.

According to an embodiment, at Step 20, in which the SSD receives the multiple data segments into which the first data is divided, the method also includes receiving a request for space for storing the data segments. The request includes the size of the data segment and the identification number of the blank block determined at Step S10. For example, according to an embodiment, the host transmits to the SSD the request for space for storing a data segment before transmitting any data segments to the SSD, and the SSD receives the request for a space for storing a data segment. In response to the request, the SSD distributes storage space for storing the data segment based on the data size and the identification number included in the request, and returns a logical address to the host that corresponds to the physical address of the storage space. Exemplarily, the physical address of the distributed storage space may indicate the page and the block in which the data segment is stored.

According to an embodiment, the distributed storage space for a first data segment begins from a beginning address of a blank block found above, and is not smaller than the first data segment.

According to an embodiment, the distributed storage space for any subsequent data segment begins from the end physical address of a previous data segment, and is not smaller than the subsequent data segment.

According to an embodiment, when an end physical address for storing a previous data segment is an end address of a block, another blank block is found, and a storage space which begins from a beginning address of the another blank block and is not smaller than the subsequent data segment is distributed to the subsequent data segment. Note that in this situation, the SSD cancels the correspondence between the identification number and the physical address of the above blank block, and establishes a new correspondence between the identification number and a physical address of another blank block, so that the SSD can distribute storage space for storing subsequent data segments based on the data size and the identification number included in the write request.

According to an embodiment, the host transmits subsequent data segments and the returned logical address to the SSD after receiving the logical address from the SSD. Although a basic unit for writing in an SSD is a page, the page size is an integer multiple of the size of the subsequent data segment. Thus, after subsequent data segments and logical address are received at Step S20, the received data segments are not immediately written but are cached until the sum of the sizes of the received data segments is equal to a size of a page. Note that the logical addresses of the data segments are continuous. In other words, when the sum of the sizes of the cached multiple data segments, which have continuous logical addresses, is equal to a page size, the cached multiple data segments are written into a physical address of a page that corresponds to the logical address of the multiple data segments at Step 30.

According to an embodiment, the distributed storage space for a first data segment begins from a beginning address of a found blank block, and is not smaller than the first data segment. Thus, at Step S30, the first data segment is written into the storage space, begins at a beginning address of a found blank block that is not smaller than the first data segment.

According to an embodiment, the distributed storage space for subsequent data segments begins from an end physical address of a previous data segment, and is not smaller than the subsequent data segment. Thus, at Step S30, a subsequent data segment is written into the distributed storage space, which begins at an end physical address of a previous data segment that has a size not less than the size of any subsequent data segment.

According to an embodiment, when an end physical address for storing a previous data segment is an end address of a block, a storage space for a subsequent data segment begins at a beginning address of another found blank block that has a storage size not less than the size of the subsequent data segment. Thus, at Step S30, a data segment is written into the distributed storage space, which begins at a beginning address of the another found blank block and whose size is not less than the size of the subsequent data segment.

According to an embodiment, when a write command for multiple other data is received substantially simultaneously with the write command for the first data at Step S10, a blank block is respectively found for each other data, the first data and the multiple other data are respectively received at Step S20, and each data is written at Step S30 beginning respectively from the blank block found respectively for each data. Here, a process of receiving and writing each data is an above process of receiving and writing the first data.

In an exemplary embodiment of the present disclosure, data is written into the blank block in a process of writing data, so that only one data is stored in each blank block. After data is deleted in a process of deleting data, that is, after a page storing the data to be deleted is marked as an invalid page, a block containing the deleted data includes an invalid page and a blank page, or includes only an invalid page, and thus it is unnecessary to move valid data in a GC process of erasing the block, which can improve the efficiency of the GC process and the usage of the SSD.

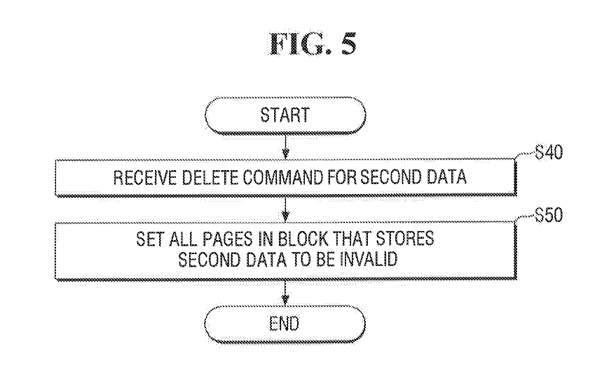

Furthermore, according to an embodiment, in a situation in which all hosts use a data processing method according to an exemplary embodiment of the present disclosure, embodiments of the present disclosure can improve an existing delete process. For example, all pages in a block which contains data to be deleted can be set to be invalid after a delete data command is received. FIG. 5 is a flowchart for deleting data in a data processing method of an SSD according to an exemplary embodiment of the present disclosure.

With reference to FIG. 5, at Step S40, a delete command for a second data is received. As an example, the host may process a received delete request after receiving the delete request, and then transmit the processed delete request as a delete command to the SSD. The delete request may include a logical address of the second data.

At Step S50, all pages in a block that store the second data are set to be invalid. Pages in an SSD can be divided into three types according to usage, namely a blank page, a valid page in which there is valid data, and an invalid page in which there is invalid data. At Step S50, the usage states of all pages in the block containing that page that stores the second data are changed from a valid state to an invalid state.

According to an embodiment, a physical address of the stored second data is determined based on the received delete request, between Steps S40 and S50. The physical address indicates a page that contains the second data and a block that contains the page that contains the second data. Here, the block containing the page that contains the second data may also be called a block for storing the second data. In particular, the physical address of the stored second data can be determined from the logical address of the second data based on a correspondence between the physical address and the logical address of the second data. The correspondence relationship between the physical address and the logical address is stored in the SSD.

In another exemplary embodiment of the present disclosure, in a write data process, a blank page in a block into which the first data is written is set to be a padding page or an invalid page, after the first data is finished writing. Thus, in a delete data process, the block that stores the data to be deleted is searched to find the padding page, and the found padding page is set to be invalid, after a page that stores the data to be deleted is set to be invalid. Setting the padding page to be invalid is useful in a situation in which some hosts of the SSD use an existing data processing method and other hosts of the SSD use a data processing method according to an exemplary embodiment of the present disclosure. A padding page is padded with predetermined data that differs from the valid data, and the padding page constitutes a fourth usage state according to an embodiment of the present disclosure, in addition to the above described three page usage states in the related art.

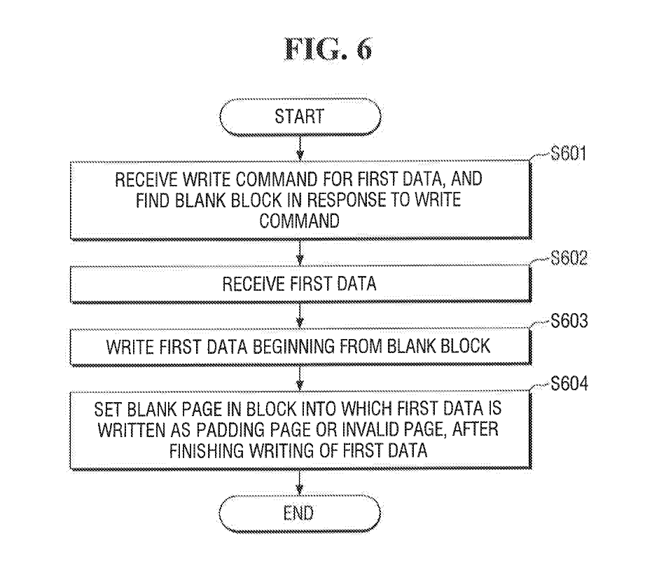

FIG. 6 is a flowchart for writing data in a data processing method of an SSD according to another exemplary embodiment of the present disclosure.

At Step S601, a write command for a first data is received, and a blank block is found in response to the write command.

At Step S602, the first data is received.

At Step S603, the first data is written beginning from the blank block.

Here, Steps S601, S602, and S603 may be performed with reference to the Steps S10, S20, and S30 in FIG. 4 respectively.

At Step S604, a blank page in a block into which the first data is written is set as a padding page, after finishing writing the first data. That is, a blank page in a block into which the first data is written is padded with other predetermined data which differs from the valid data.

In another embodiment, at Step S604, a blank page in a block into which the first data is written may be set to be invalid after finishing writing the first data.

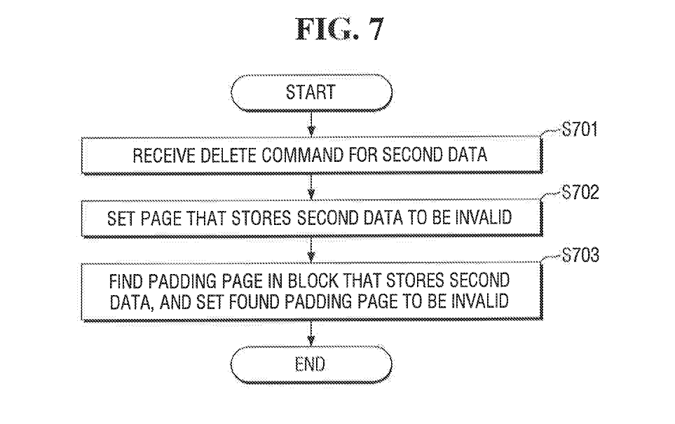

FIG. 7 is a flowchart for deleting data in a data processing method of an SSD according to another exemplary embodiment of the present disclosure.

At Step S701, a delete command for a second data is received.

At Step S702, a page that stores the second data is set to be invalid.

At Step S703, a padding page is found in a block that stores the second data, and the found padding page is set to be invalid.

According to an embodiment, Step S701 is performed with reference to Step S40 in FIG. 5, and Step 702 is performed with reference to Step S50 in FIG. 5.

In a process of writing data, in another embodiment in which a blank page in the block into which the first data is written is set to be invalid after writing the first data is finished, Step S703 is not performed when deleting data.

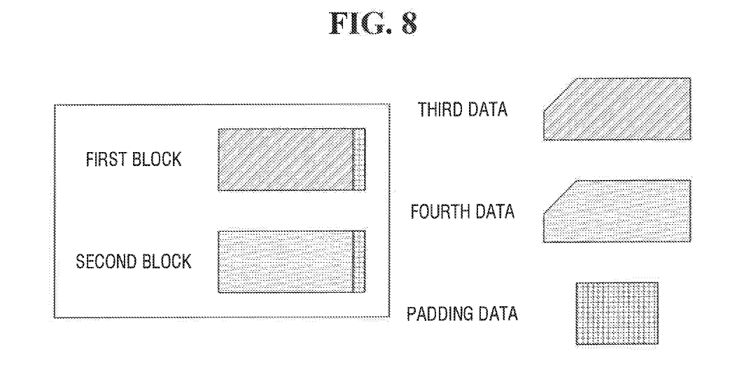

Processes of writing data, deleting data, and GC according to another exemplary embodiment of the present disclosure will be described below with reference to FIGS. 8-10.

FIG. 8 illustrates an example of a data distribution after a third data and a fourth data are written into the SSD according to a data write process of an exemplary embodiment of the present disclosure. As shown in FIG. 8, the sizes of the third data and the fourth data are both less than a size of a block, the third data is completely written into the first block, a page in the first block not containing the third data is padded with a predetermined data, the fourth data is completely written into the second block, and a page in the second block not containing the fourth data is padded with a predetermined data.

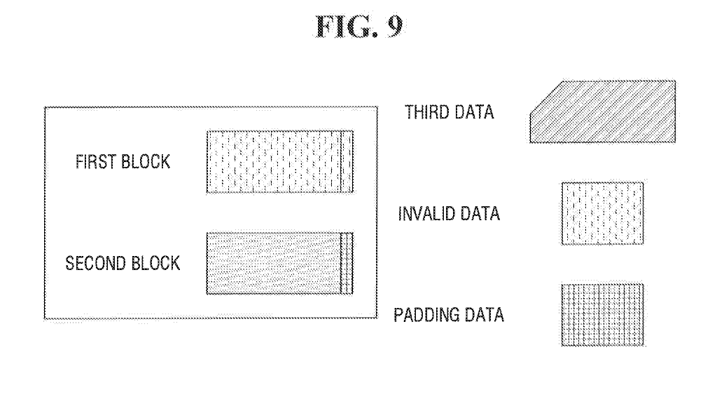

FIG. 9 illustrates an example of a data distribution in the SSD after the third data in FIG. 8 is deleted according to a data delete process of an exemplary embodiment of the present disclosure. As show in FIG. 9, a page in the first block that stores the third data and a page in the first block padded with the predetermined data are both set to be invalid, that is, all pages in the first block are set to be invalid; there is no page that stores the third data in the second block, so it is unnecessary to process the second block.

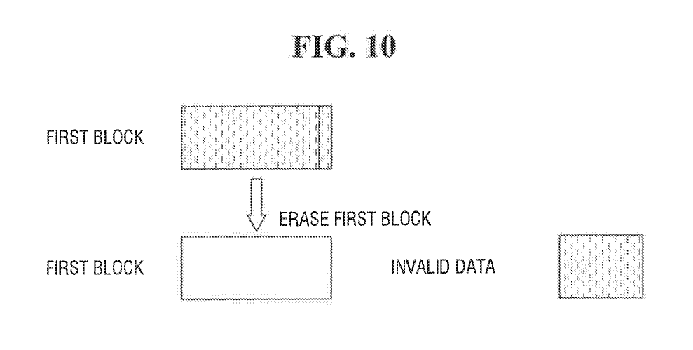

FIG. 10 illustrates a method for erasing the first block in FIG. 9. As show in FIG. 10, all pages in the first block are invalid pages, and there is no valid data in the first block, so it is unnecessary to move the valid data, and the first block can be directly erased.

Therefore, valid data is not moved in a GC process, by writing and deleting data according to a data processing method of an exemplary embodiment of the present disclosure.

It will be understood by those skilled in the art that an above embodiment illustrated in FIGS. 8-10 is exemplary and non-limiting. For example, a page in the first block in FIG. 8 into which the third data is not written may not be padded with the predetermined data, but may be set to be invalid, and in the deleting process of FIG. 9, a page in the first block not containing the third data is set to be invalid and there is no padded page in the first block, so it is unnecessary to find a padding page, and valid data is not moved in the GC process.

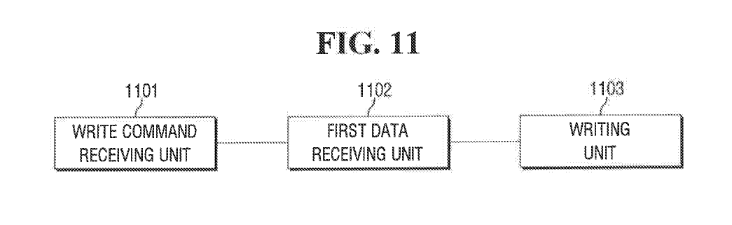

FIG. 11 is a block diagram of a data writing module in a data processing apparatus of an SSD according to an exemplary embodiment of the present disclosure. With reference to FIG. 11, a data write module in a data processing apparatus of an SSD according to an exemplary embodiment of the present disclosure includes a write command receiving unit 1101, a first data receiving unit 1102, and a writing unit 1103.

According to an embodiment, the write command receiving unit 1101 receives a write command for a first data, and finds a blank block in response to the write command. Here, the write command indicates that the first data is being into the blank block. Each page included in the blank block is a blank page, and the blank block is used only for storing the first data.

According to an embodiment, when receiving a request to write the first data, the host will transmit the write command for the first data to the SSD, and the write command receiving unit 1101 will find a blank block after receiving the command. For example, the write command receiving unit 1101 can search for a blank block. Then the SSD returns an execution result of the command, such as success or failure, to the host. Furthermore, the apparatus may also include an identification number transmitting unit, and the identification number transmitting unit is used to return an identification number of the found blank block to the host. The identification number may be defined by the SSD itself, or may correspond with a physical address of the blank block, but embodiments are not limited thereto, and the identification number may use any other feasible form.

According to an embodiment, the host will transmit the first data to the SSD after receiving the above execution result. The host may also transmit the identification number of the blank block to the SSD. Here, the host may transmit the identification number of the blank block either before or while transmitting the first data. Accordingly, the apparatus further may include an identification number receiving unit, and the identification number receiving unit is used to receive the identification number of the blank block from the host.

The first data receiving unit 1102 receives the first data.

According to an embodiment, the host divides the first data into multiple data segments after receiving the write request for the first data, and transmits the multiple data segments to the SSD after receiving the above execution result. The size of each data segment is less than a page size. For example, the page size is an integer multiple of the size of the data segment. Accordingly, the first data receiving unit 1102 receives the multiple data segments into which the first data is divided.

According to an embodiment, the writing unit 1103 writes the first data beginning from the blank block. Here, the first data is written beginning from a blank block indicated by the identification number of the blank block, according to the received blank block identification number. In other words, the first data is written beginning from the blank block found by the write command receiving unit 1101. For example, the first data is written beginning from a beginning address of the blank block.

According to an embodiment, whenever one blank block is filled but the first data is incompletely written, the write unit 1103 writes unwritten content of the first data continuously into another blank block. For example, the writing unit 1103 writes unwritten content of the first data continuously from a beginning address of another blank block.

According to an embodiment, when the first data receiving unit 1102 receives multiple data segments of the first data, the writing unit 1103 writes the multiple data segments beginning from the blank block. The beginning address of the blank block is a beginning physical address for storing a first data segment, and a physical address for storing a subsequent data segment follows the physical address for storing a previous data segment.

According to an embodiment, whenever a blank block is filled but the multiple data segments are incompletely written, the writing unit 1103 writes an unwritten data segment of the multiple data segments continuously from another blank block. In other words, when an end physical address for storing the previous data segment is an end address of a block, the physical address for storing a subsequent data segment is a beginning address of another blank block.

According to an embodiment, the multiple data segments are divided into a plurality of data segment groups. Whenever the first data receiving unit 1102 receives one data segment group, the writing unit 1103 performs the writing once, and whenever a blank block is filled, but there is an incompletely written or unwritten data segment group, the writing unit 1103 writes the unwritten part of the incompletely written data segment group or the unwritten data segment group continuously from another blank block.

In particular, according to an embodiment, the data segment group is composed of multiple continuous data segments, and a sum of the data segment sizes is equal to a page size. A page is the basic unit for writing in the SSD, but the size of each data segment is less than the size of the page, so to efficiently use a storage space, the writing unit 1103 does not immediately write data segments received from the first data receiving unit 1102 but rather caches the data segments until a sum of the sizes of the received continuous data segments is equal to the page size. In other words, when the sum of the sizes of multiple cached continuous data segments is equal to the page size, the writing unit 1103 writes the multiple cached continuous data segments into a physical address of a page that corresponds to the logical addresses of the multiple data segments. That is, whenever the first data receiving unit 1102 receives one data segment group, the writing unit 1103 performs the writing once.

According to an embodiment, when the first data receiving unit 1102 receives the multiple data segments into which the first data is divided, the apparatus further may include a space request receiving unit, which receives a request for space for storing a data segment. The request may include the size of the data segment and the identification number of the blank block found by the write command receiving unit 1101. For example, the host transmits to the SSD the request for space for storing a data segment before transmitting any data segment to the SSD and the space request receiving unit receives the request for space for storing a data segment. In response to the request, the space request receiving unit distributes a storage space for storing the data segment based on the data size and the identification number included in the request, and returns a logical address to the host that corresponds to a physical address of the storage space. Exemplarily, the physical address of the distributed storage space may indicate the page and block in which the data segment is stored.

According to an embodiment, the distributed storage space for a first data segment begins from a beginning address of the found blank block, and is not smaller than the first data segment.

According to an embodiment, the distributed storage space for any subsequent data segment begins from an end physical address of a previous data segment, and is not smaller than the subsequent data segment.

According to an embodiment, when an end physical address for storing the previous data segment is an end address of a block, another blank block is found, and a storage space which begins from a beginning address of the other blank block and is not smaller than the subsequent data segment is distributed to the subsequent data segment. Note that in this situation, the SSD cancels the correspondence between the identification number and the physical address of the above blank block, and establishes a new correspondence between the identification number and the physical address of the another found blank block, so that the SSD can distribute the storage space for storing subsequent data segments based on the data size and the identification number included in the write request.

According to an embodiment, the host transmits subsequent data segments and the returned logical address to the SSD after receiving the logical address from the SSD. Although a basic unit for writing in the SSD is a page, the page size is an integer multiple of the size of the subsequent data segment. Thus, after the first data receiving unit 1102 receives a subsequent data segment and the logical address, the writing unit 1103 does not immediately write the received data segments but rather caches the received data segments until the sum of the sizes of the received data segments is equal to a size of a page. Note that the logical addresses of the data segments are continuous. In other words, when the sum of the sizes of the cached multiple data segments is equal to a page size, the writing unit 1103 writes the cached multiple data segments into a physical address of a page that corresponds to a logical address of the multiple data segments.

According to an embodiment, the distributed storage space for a first data segment begins from a beginning address of the found blank block, and is not smaller than the first data segment, so the writing unit 1103 writes the first data segment into a storage space which begins from a beginning address of a found blank block that is not smaller than the first data segment.

According to an embodiment, the distributed storage space for subsequent data segments begins from an end physical address of a previous data segment, and is not smaller than a subsequent data segment. Thus, the writing unit 1103 writes subsequent data segments into the distributed storage space, which begins from an end physical address of a previous data segment, and is not smaller than the subsequent data segment.

According to an embodiment, when an end physical address for storing the previous data segment is an end address of a block, a storage space for a subsequent data segment begins from a beginning address of the found another blank block that has a storage size not less than the size of the subsequent data segment, so the writing unit 1103 write subsequent data segments into the distributed storage space, which begins from a beginning address of the found another blank block and is not smaller than the subsequent data segment.

According to an embodiment, when the write command receiving unit 1101 receives a write command for multiple other data substantially simultaneously with receiving the write command for the first data, the write command receiving unit 1101 finds a blank block for each other data, the first data receiving unit 1102 receives the first data and the multiple other data, and the writing unit 1103 writes each data beginning from the blank block found respectively for each data. Here, a process of receiving and writing each data is an above process of receiving and writing first data.

In an exemplary embodiment of the present disclosure, data is written into the blank block by a data writing module, so that only one data is stored in each blank block. After data is deleted in a process of deleting data, that is after a page storing the data to be deleted is marked as an invalid page, a block containing the deleted data includes an invalid page and a blank page, or includes only an invalid page, and thus it is unnecessary to move valid data in a GC process of erasing the block, which can improve the efficiency of the GC process and the usage of the SSD

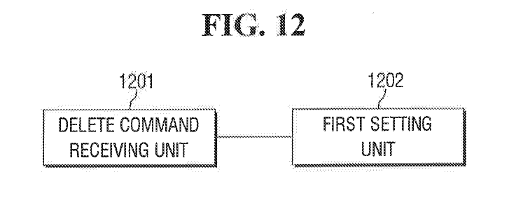

Furthermore, according to an embodiment, in a situation in which all hosts use a data processing apparatus according to an exemplary embodiment of the present disclosure, embodiments of the present disclosure can improve an existing delete process. For example, all pages in a block which contain data to be deleted are set to be invalid after a delete data command is received. FIG. 12 is a block diagram of a data deleting module in a data processing apparatus of an SSD according to an exemplary embodiment of the present disclosure. With reference to FIG. 12, a data deleting module in a data processing apparatus of an SSD according to an exemplary embodiment of the present disclosure includes a delete command receiving unit 1201 and a first setting unit 1202.

According to an embodiment, the delete command receiving unit 1201 receives a delete command for a second data. For example, the host processes the received delete request after receiving a delete demand, and transmits the processed delete request as a delete command to the SSD. The deletion request may include a logical address of the second data.

According to an embodiment, the first setting unit 1202 sets all pages in a block that stores the second data to be invalid. The first setting unit 1202 changes usage states of all pages in the block which contains a page that stores the second data from a valid state to an invalid state.

Here, the data deleting module may include a physical address determining unit. The physical address determining unit determines a physical address of the stored second data based on the received delete command, and the physical address indicates the page that contains the second data and a block that contains the page that contains the second data. Here, the block containing the page that contains the second data may also be called a block for storing the second data. In particular, the physical address determining unit determines the physical address of the stored second data from the logical address of the second data based on a correspondence between the physical address and the logical address of the second data. The correspondence between the physical address and the logical address is stored in the SSD.

In another exemplary embodiment of the present disclosure, the writing data module sets a blank page in a block into which the first data is written as a padding page or an invalid page, after finishing writing the first data. Thus, in a delete data process, a block that stores the data to be deleted is searched to find the padding page, and the found padding page is set to be invalid, after a page that stores the data to be deleted is set to be invalid. Setting the padding page to be invalid is useful in a situation in which some hosts of the SSD use an existing data processing method and other hosts of the SSD use a data processing method according to an exemplary embodiment of the present disclosure. The padding page is padded with predetermined data which differs from valid data, and the padding page constitutes a fourth usage state according to an embodiment of the present disclosure in addition to the above described three page usage states in the related art.

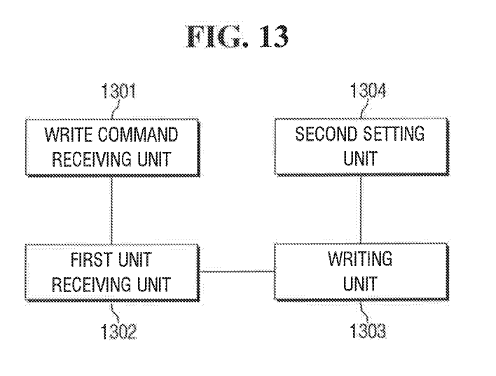

FIG. 13 is a block diagram of a data writing module in a data processing apparatus of an SSD according to another exemplary embodiment of the present disclosure. With reference to FIG. 13, a data writing module in a data processing apparatus of an SSD according to another exemplary embodiment of the present disclosure includes a write command receiving unit 1301, a first data receiving unit 1302, a writing unit 1303 and a second setting unit 1304.

According to an embodiment, the write command receiving unit 1301 receives a write command for a first data, and finds a blank block in response to the write command.

The first data receiving unit 1302 receives the first data.

According to an embodiment, the writing unit 1303 writes the first data beginning from the blank block.

Here, functions of the writing command receiving unit 1301, the first data receiving unit 1302, and the writing unit 1303 are substantially the same as the writing command receiving unit 1101, the first data receiving unit 1102, and the writing unit 1103 in FIG. 11, respectively.

According to an embodiment, the second setting unit 1304 sets a blank page in a block into which the first data is written as a padding page after finishing writing the first data. That is, the second setting unit 1304 pads a blank page in a block into which the first data is written with predetermined fixed data which differs from valid data.

In another embodiment, the second setting unit 1304 sets a blank page in a block into which the first data is written to be invalid after finishing writing the first data.

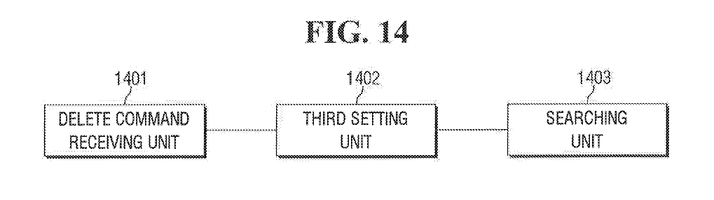

FIG. 14 is a block diagram of a data deleting module in a data processing apparatus of an SSD according to another exemplary embodiment of the present disclosure. With reference to FIG. 14, a data deleting module in a data processing apparatus of an SSD according to another exemplary embodiment of the present disclosure includes a delete command receiving unit 1401, a third setting unit 1402, and a searching unit 1403.

The deletion command receiving unit 1401 receives a delete command of a second data.

The third setting unit 1402 sets a page that stores the second data to be invalid.

The searching unit 1403 finds a padding page in a block that stores the second data, and sets the found padding page to be invalid.

Here, the functions of the deletion command receiving unit 1401 and the third setting unit 1402 are substantially the same as the deletion command receiving unit 1201 and the first setting unit 1202 in FIG. 12, respectively.

In another embodiment in which the second setting unit in a data writing module sets a blank page in the block into which the first data is written to be invalid after finishing writing the first data, the data deleting module may not include the searching unit 1403.

In a data processing method and apparatus of an SSD according to exemplary embodiments of the present disclosure, data is only written into the blank block in a data writing process, so that only one data is stored in each block. In addition, when data is deleted, the page storing the data to be deleted is marked as invalid, the block storing the data to be deleted only includes the invalid page and a blank page, or only includes the invalid page, and thus valid data need not be moved during a garbage collection process of erasing the block, which can improve an efficiency of the garbage collection and a usage of the SSD. A data processing method and apparatus of an SSD according to embodiments of the present disclosure can be applied to storage processing of various data, such as storage processing in a server of a large data center. Furthermore, because data processing for a system which uses a log structured-merge (LSM) file organization only includes two kinds of operations, namely writing and deleting, a data processing method and apparatus of an SSD according to embodiments of the present disclosure can be applied to the system which an LSM file organization.

Furthermore, it should be understood that a data processing method of an SSD according to an exemplary embodiment of the present disclosure may also be embodied as a computer readable code on a computer readable recording medium. A computer readable recording medium is any data storage device that can store data, which can thereafter be read by a computer system. Examples of computer readable recording medium include a read-only Memory (ROM), a random-access memory (RAM), a CD-ROM, a magnetic tape, a floppy disk, and an optical data storage device. A computer readable recording medium can also be distributed over a network coupled computer system, so that computer readable code is stored and executed in a distributed fashion. Furthermore, a functional program, a code, and a code segment for accomplishing an embodiment of the present disclosure can be produces by a programmer having ordinary skill in the art directed to embodiments the present disclosure is within the scope of embodiments of the present disclosure.

Furthermore, a respective unit in a data processing apparatus of an SSD according to an exemplary embodiment of the present disclosure can be implemented as a hardware component. Those skilled in the art may implement a respective unit, for example, by using a field programmable gate array (FPGA) or an application specific integrated circuit (ASIC) according to a processing performed by the defined respective unit.

While embodiments of the present disclosure have been presented and described with reference to the exemplary embodiments in detail, it should be understood by those skilled in the art that various changes in form and details may be made therein without departing from the spirit and scope of the present disclosure which is defined by the appended claims.

What is claimed is:

1. A method of processing data in a solid state disk (SSD), the method comprising the steps of:
receiving a write command for a first data, and finding a blank block in response to the write command, wherein each page included in the blank block is a blank page;
receiving the first data; and
writing the first data beginning from the blank block.

2. The method of claim 1, wherein writing the first data beginning from the blank block comprises: when one blank block is filled but the first data is incompletely written,
writing unwritten content of the first data continuously from another blank block.

3. The method of claim 1, wherein
the first data comprises multiple data segments,
receiving the first data comprises receiving the multiple data segments included in the first data, and
writing the first data beginning from the blank block comprises writing the multiple data segments beginning from a beginning address of the blank block,
wherein the beginning address of the blank block is a beginning physical address to store a first data segment, and a physical address to store a subsequent data segment follows a physical address of a stored previous data segment.

4. The method of claim 3, wherein writing the first data beginning from the blank block further comprises:
when a blank block is filled but the multiple data segments are incompletely written, writing an unwritten data segment in the multiple data segments continuously from a beginning address of another blank block,
wherein when an end physical address of previously stored data segment is an end address of a block, the physical address to store a subsequent data segment begins from the beginning address of the another blank block.

5. The method of claim 4, wherein the multiple data segments are divided into a plurality of data segment groups, and writing the first data beginning from the blank block comprises:
when receiving one data segment group, performing the writing once, and
when a blank block is filled, but there is an incompletely written or unwritten data segment group, writing an unwritten part of the incompletely written data segment group, or the unwritten data segment group, continuously from another blank block

6. The method of claim 1, further comprising:
transmitting an identification number of the found blank block to a host after receiving the write command for the first data; and
receiving the identification number of the blank block,
wherein writing the first data beginning from the blank block comprises:
writing the first data beginning from a blank block indicated by the identification number.

7. The method of claim 1, wherein when receiving a write command for multiple other data simultaneously with the write command for the first data, the method further comprises:
determining a blank block respectively for each data;
receiving the first data and the multiple other data respectively; and
writing each data beginning respectively from the blank block respectively determined for each data.

8. The method of claim 1, further comprising:
receiving a delete command for a second data; and
setting all pages in a block that store the second data to be invalid.

9. The method of claim 1, further comprising, after finishing writing the first data:
setting a blank page in a block into which the first data is written as a padding page, or
setting a blank page in a block into which the first data is written as an invalid page.

10. The method of claim 8, further comprising:
finding a padding page in a block that stores the second data, and setting the found padding page to be invalid.

11. An apparatus for processing data in a solid state disk (SSD), comprising:
a write command receiving unit that receives a write command for a first data and determines a blank block in response to the write command, wherein each page included in the blank block is a blank page;
a first data receiving unit that receives the first data; and
a writing unit that writes the first data beginning from the blank block.

12. The apparatus of claim 11, wherein when one blank block is filled but the first data is incompletely written, the writing unit writes an unwritten content of the first data continuously from another blank block.

13. The apparatus of claim 11, wherein
the first data comprises multiple data segments,
the first data receiving unit respectively receives the multiple data segments included in the first data, and
the writing unit writes the multiple data segments beginning from a beginning address of the blank block,
wherein the beginning address of the blank block is a beginning physical address to store a first data segment, and a physical address to store a subsequent data segment follows a physical address of a previously stored data segment.

14. The apparatus of claim 13, wherein when a blank block is filled but the multiple data segments are incompletely written, the writing unit writes an unwritten data segment of the multiple data segments continuously from a beginning address of another blank block,
wherein when an end physical address of the previously stored data segment is an end address of a block, the physical address to store a subsequent data segment begins from the beginning address of the another blank block.

15. The apparatus of claim 14, wherein the multiple data segments are divided into a plurality of data segment groups, and whenever the first data receiving unit receives one data segment group, the writing unit performs the writing once,
wherein when a blank block is filled, but there is an incompletely written or unwritten data segment group, the writing unit writes a remaining part of the incompletely written data segment group, or the unwritten data segment group, continuously from another blank block.

16. The apparatus of claim 11, wherein when the write command receiving unit receives a write command for multiple other data simultaneously with receiving the write command for the first data, the write command receiving unit finds a blank block for each other data, the first data receiving unit receives the first data and the multiple other data, and the writing unit writes each data beginning from the blank block found respectively for each data.

17. The apparatus of claim 11, wherein the writing data module sets a blank page in a block into which the first data is written as a padding page or an invalid page, after finishing writing the first data, and the apparatus further comprises:
a second setting unit that sets a blank page in a block into which the first data is written as a padding page or an invalid page after finishing writing the first data is finished.

18. The apparatus of claim 11, further comprising:
a delete command receiving unit that receives a delete command for a second data; and
a first setting unit that sets all pages in a block that store the second data to be invalid.

19. The apparatus of claim 17, wherein the searching unit finds a padding page in a block that stores the second data, and sets the found padding page to be invalid.

20. A method of processing data in a solid state disk (SSD), the method comprising the steps of:
receiving a write command for a first data, and finding a blank block in response to the write command, wherein each page included in the blank block is a blank page;
receiving a delete command for a second data; and
setting all pages in a block that store the second data to be invalid.
